(19) United States
(12) Patent Application Publication
(10) Pub. No.: US 2008/0136589 A1
(43) Pub. Date: Jun. 12, 2008

(54) Multi-function replica traffic light

(76) Inventor: Scott F. Baird, Benicia, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/638,032

(22) Filed: Dec. 12, 2006

(51) Int. Cl. H04B 1/02; G08B 21/00; G08B 17/10

(52) U.S. Cl. 340/5.64; 340/628; 340/540; 340/632

(57) ABSTRACT

A multi-function replica traffic light device is disclosed. The device includes a plurality of lights of different colors aligned in a direction. The device also includes at least two selected from the group consisting of a motion detector, a timer, an audio detector, a gas detector, a smoke detector, and a visible light detector, each of which is configured to generate a signal. The device further includes a processor configured to turn on and off the plurality of lights in response to the signal.

### BACKGROUND OF THE INVENTION

1. Field of the Invention

The present invention relates to a replica traffic light. More particularly, the present invention relates to a replica traffic light having multiple functions.

2. Description of the Related Art

Replica traffic lights mimic the appearance of traffic lights typically found at road intersections. Replica traffic lights have been used for decorative purposes in homes or businesses. Alternatively, replica traffic lights have been used for educational purposes for children.

Replica traffic lights have also been functionally used employing their own directional functions. For example, a replica-type traffic light has been disclosed as a vehicle parking guide for garage use (e.g., Park-Zone available from www.accidentzone.com). The parking guide consists of a sensor unit and a display unit connected to each other by a cable. The sensor unit is mounted at bumper level on the front wall of a garage. The display unit is mounted above the sensor unit at roughly the eye level of a driver. The display unit has three lights (green, yellow, and red) similar to those of a conventional traffic light. Each of the lights sequentially turns on and off as the vehicle enters the garage and approaches the sensor unit.

The replica traffic lights described above each have only one dedicated use which is decorative, educational, or functional. However, given such versatility of a replica traffic light, there is a need to provide a replica traffic light having multiple functions to maximize its versatility while minimizing space consumption.

### SUMMARY OF THE INVENTION

One embodiment of the invention provides a multi-function replica traffic light device. The replica traffic light device comprises a plurality of lights of different colors aligned in a direction. The replica traffic light device further includes at least two selected from the group consisting of a motion detector, a timer, an audio detector, a gas detector, a smoke detector, and a visible light detector. Each of the foregoing is configured to generate a signal. The replica traffic light device also includes a processor configured to turn on and off the plurality of lights in response to the signal.

The plurality of lights can comprise a red light, a yellow light, and a green light. The direction can comprise one of a vertical direction and a horizontal direction. The processor can be configured to sequentially or randomly turn on and off the plurality of lights.

The motion detector can be configured to detect motion of an object and generate a signal in response to the motion. The timer can be configured to set a duration for which the processor is on. The audio detector can be configured to detect a sound and generate a signal in response to the sound. The gas detector can be configured to detect a gas in the air and generate a signal if the gas is in an amount greater than a predetermined value.

The visible light detector can be configured to generate a signal upon receiving visible light if the visible light has a luminance greater than a predetermined value. In another embodiment, the visible light detector can be configured to generate a signal if ambient light has a luminance lower than a predetermined value. In such an embodiment, the processor can be configured to be turned on upon receiving the signal from the visible light detector. In yet another embodiment, the replica traffic light device can further comprise a wireless receiver configured to receive a wireless signal from a remote controller.

### BRIEF DESCRIPTION OF THE DRAWINGS

FIG. 1 illustrates a replica traffic light including multiple detectors according to one embodiment.

FIG. 2 illustrates a replica traffic light including multiple detectors according to another embodiment.

FIG. 3 illustrates the operation of the replica traffic light of FIG. 2, using a motion detector.

FIG. 4 illustrates a replica traffic light serving as a parking assistant according to another embodiment.

### DETAILED DESCRIPTION OF THE PREFERRED EMBODIMENT

Various aspects and features of the instant disclosure will become more fully apparent from the following description and appended claims taken in conjunction with the foregoing drawings. In the drawings, like reference numerals indicate identical or functionally similar elements.

### Configuration of Replica Traffic Light

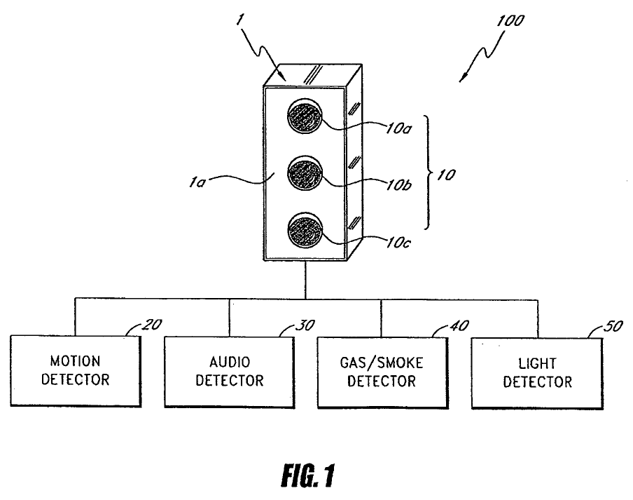

FIG. 1 illustrates a replica traffic light 100 according to one embodiment. The replica traffic light 100 includes a housing 1, a plurality of lights 10, various detectors 20, 30, 40, 50, and a processor (not shown). The housing 1 is configured to house the plurality of lights 10 and the processor. The plurality of lights 10 are electrically connected to the processor. The illustrated detectors 20, 30, 40, 50 are positioned outside the housing 1 while being electrically connected to the processor via cables. In another embodiment, at least one of the detectors 20, 30, 40, 50 can communicate with the processor via a wireless connection. In certain embodiments, at least one of the detectors 20, 30, 40, 50 can be built-in within the housing 1.

The housing 1 serves as a frame for the plurality of lights 10. The housing 1 exposes the lights 10 through the front surface 1a thereof. In addition, the housing 1 encloses electrical parts of the lights 10. The front surface 1a of the housing 1 has a rectangular shape similar to that of a real traffic light. In other embodiments, the housing 1 can have various other shapes. The housing 1 can also have various colors such as black, blue, green, red, or yellow. The housing 1 can be formed of any suitable material, including, but not limited to, a plastic material and a metallic material.

The plurality of lights 10 include a red light 10a, a yellow light 10b, and a green light 10c. In some embodiments, at least one of the lights 10a, 10b, and 10c can have a different color, for example, white or blue. In another embodiment, the replica traffic light 100 can only have two lights of different colors, for example, red and green. In yet another embodiment, the replica traffic light 100 can have four lights including a red light, a yellow light, a green light, and a green light with a left turn arrow (←) and/or a right turn arrow (→). The illustrated lights 10a, 10b, and 10c are aligned in a vertical direction. In another embodiment, the lights 10a, 10b, and 10c can be aligned in a horizontal direction. It will be appreciated that various other configurations of lights are possible.

The detectors can include, for example, a motion detector 20, an audio detector 30, a gas/smoke detector 40, and a light detector 50. The detectors 20, 30, 40, 50 are positioned at locations which allow them to function as designed. The configurations of the sensors 20, 30, 40, 50 will be described later in detail.

The illustrated replica traffic light 100 has the four detectors 20, 30, 40, 50 described above. In other embodiments, the replica traffic light 100 can have only one, two, or three of the detectors 20, 30, 40, 50. In certain embodiments, the replica traffic light 100 can have additional detectors of the same kind. Preferably, these additional detectors are positioned at different locations from the detectors 20, 30, 40, 50 described above. A skilled artisan will appreciate that the replica traffic light 100 can also have an additional detector of a different kind depending on its needs.

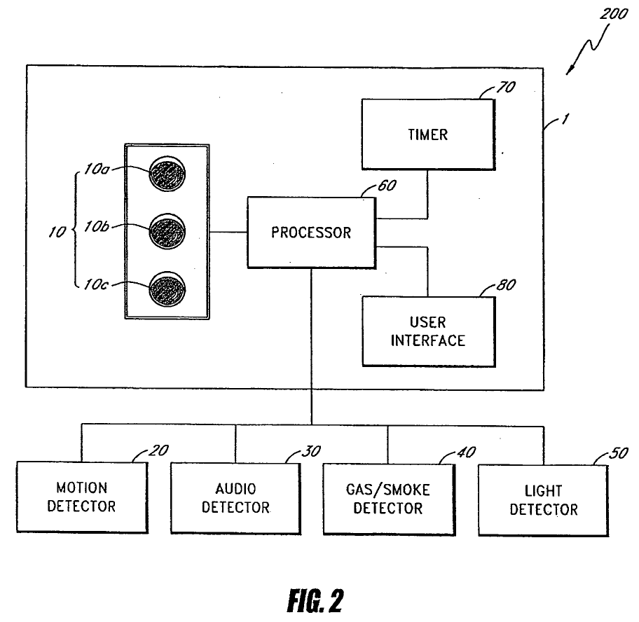

FIG. 2 is a block diagram illustrating a replica traffic light 200 according to another embodiment. The replica traffic light 200 includes a housing 1, a plurality of lights 10, a motion detector 20, an audio detector 30, a gas/smoke detector 40, a light detector 50, a processor 60, a timer 70, and a user interface 80. The configurations of the housing 1 and the lights 10 are as described above with respect to those of the replica traffic light 100 of FIG. 1.

The motion detector 20 is configured to detect a motion of a moving object and generate a signal according to the motion. In detecting a motion, the motion detector 20 can use, for example, a radio frequency wave, ultrasound, microwave, infrared, and the like. The motion detector 20 can include, for example, a Senscomp 6500 ultrasonic ranging module and a Series 7000 transducer (both available from SensComp, Inc., Livonia, Mich.). It will be appreciated that any suitable motion detector can be adapted for use in the replica traffic light 200.

The audio detector 30 is configured to detect a sound and generate a signal according to the sound. The audio detector 30 can detect, for example, the frequency, volume, and/or rhythm of a sound. The audio detector 30 can include a microphone and an amplifier. An exemplary audio detector is SOUND SENSOR 017i available from Centre for Microcomputer Applications, Amsterdam, the Netherlands. In certain embodiments, the audio detector 30 can be configured to detect music, speech, or clap. It will be appreciated that any suitable audio detector can be adapted for use in the replica traffic light 200.

The gas/smoke detector 40 is configured to detect a specific gas and smoke and generate a signal if an amount of the gas or smoke exceeds a predetermined value. The illustrated gas/smoke detector 40 includes a gas detector and a smoke detector integrated with each other. The gas detector can detect a hazardous gas such as carbon monoxide and/or a flammable gas (e.g., LPG and LNG). An exemplary gas detector is ST666-1 (available from Scitron, China). The smoke detector can detect airborne smoke. The smoke detector can operate either by optical detection and/or by ionization detection. It will be appreciated that any suitable gas/smoke detector can be adapted for use in the replica traffic light 200. In another embodiment, the gas/smoke detector 40 can include a gas detector and a smoke detector separated from each other. In such an embodiment, the gas detector and smoke detector can be positioned at different locations. In yet another embodiment, the replica traffic light 200 can have multiple gas/smoke detectors depending on needs.

The light detector 50 is configured to detect visible light and generate a signal if the visible light has a luminance greater than a predetermined luminance value. In another embodiment, the visible light detector 50 can be configured to generate a signal if ambient light has a luminance lower than a predetermined value. The light detector 50 can include a phototransistor and an amplifier. An exemplary light detector is LS-BTA available from www.vernier.com. It will be appreciated that any suitable light detector can be adapted for use in the replica traffic light 200.

The illustrated detectors 20, 30, 40, 50 are positioned outside the housing 1 and at suitable locations for the proper functioning of the detectors 20, 30, 40, 50. In other embodiments, at least one of the detectors 20, 30, 40, 50 can be built-in within the housing 1.

The processor 60 is configured to receive signals from the detectors 20, 30, 40, 50 described above. The processor 60 is also configured to control the lights 10 as programmed upon receiving signals from the detectors 20, 30, 40, 50. The processor 60 can include a microprocessor. The processor 60 can also include a memory device such as a read-only memory (ROM) to store a software program therein. Examples of a ROM include, but are not limited to, an electrically programmable ROM (EPROM) and an electrically erasable programmable ROM (EEPROM) (e.g., a flash ROM). The processor 60 can also include a random access memory (RAM) which temporarily stores electronic data. A skilled artisan will appreciate that various types of microprocessors and memory devices can be adapted for use in the replica traffic light 200.

The processor 60 controls the lights 10 according to instructions from the software program upon receiving signals from the detectors 20, 30, 40, 50. For example, the processor 60 can sequentially turn on and off the lights 10 upon receiving signals from at least one of the detectors 20, 30, 40, 50. In another embodiment, the processor 60 can randomly turn on and off the lights 10 for decorative purposes, regardless of receiving signals from the detectors 20, 30, 40, 50. In certain embodiments, while randomly turning on and off the lights 10 for decorative purposes, the processor 60 can switch to sequential control of the lights 10 upon receiving signals from the detectors 20, 30, 40, 50. Detailed operational examples will be described later.

The timer 70 is configured to set a duration for which the processor 60 is on. The timer 70 can keep the processor 60 on for a predetermined period of time after the processor 60 is turned on. In another embodiment, the time 70 can turn on and off the processor 60 as programmed by a user via the user interface 80.

The user interface 80 is configured to allow a user to set various properties for operating the replica traffic light 200. For example, the user interface 80 can allow a user to turn on or off at least one of the detectors 20, 30, 40, 50 of the replica traffic light 200. The user interface 80 can also allow a user to program the timer 70. The user interface 80 can include a display device and an input device. The display device can include a liquid crystal display (LCD). The input device can include various buttons. The buttons can include buttons for “start time,” “day,” “hour,” “minute,” “duration,” and the like. A skilled artisan will appreciate that the configuration of the user interface 80 can vary depending on the design of the replica traffic light 200.

In other embodiments, the replica traffic light 200 can further include various other components depending on the usage thereof. Examples of such components include, but are not limited to, a CD player, a DVD player, a cassette player, an MP3 player with iPod® connection or USB connector, a clock (including an alarm clock), a telephone, an intercom speaker and receiver, a radio receiver, a video camera, and a liquid crystal display (LCD) monitor. In certain embodiments, the replica traffic light 200 can be adapted to be useful in a garage workshop. In such embodiments, the replica traffic light 200 can have a lighting fixture, a tool hanger, an electric socket, and the like on the exterior surface of the housing 1.

### Operation of Replica Traffic Light

Referring again to FIG. 2, the processor 60 can turn on and off the lights 10 as programmed. For example, the processor 60 can sequentially turn on and off the lights 10 upon receiving signals from at least one of the detectors 20, 30, 40, 50. In the illustrated embodiment, the processor 60 can sequentially turn on and off the green, yellow, and red lights 10c, 10b, 10a.

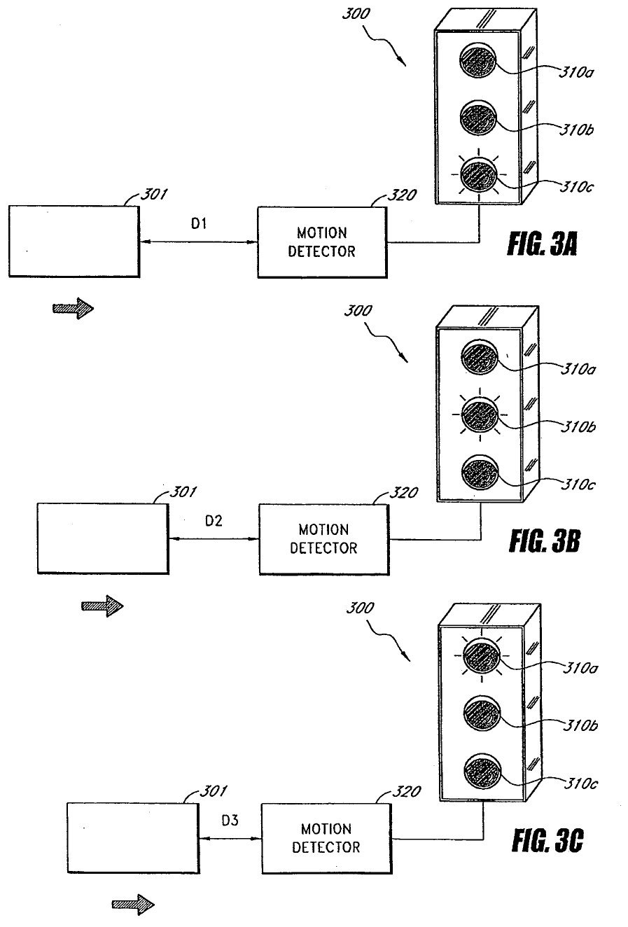

FIG. 3 illustrates one embodiment in which a replica traffic light 300 turns on and off a red light 310a, a yellow light 310b, and a green light 310c according to signals from a motion detector 320. As an object 301 approaches the motion detector 320, the motion detector 320 detects the motion of the object 301 and generates a signal corresponding to the motion. A processor (not shown) housed in the replica traffic light 300 receives the signal and sequentially turns on and off the lights 310c, 310b, 310a.

In FIG. 3A, the object 301 is beyond a first predetermined distance D1 from the motion detector 320. The green light 310c, for example, is turned on. In FIG. 3B, the object 301 comes closer to the motion detector 320. The object 301 is now within the first predetermined distance D1 and beyond a second predetermined distance D2 from the motion detector 320. The distance D2 is shorter than the distance D1. Then, the green light 310c is turned off and the yellow light 310b is turned on. In FIG. 3C, the object 301 further approaches the motion detector 320. The object 301 is now within the second predetermined distance and beyond a third predetermined distance D3 from the motion detector 320. The distance D3 is shorter than the distance D2. Then, the yellow light 310b is turned off and the red light 310a is turned on.

In one embodiment, the distance D1 can be from about 5 feet to about 15 feet. The distance D2 can range from about 2 feet to about 5 feet. In addition, the distance D3 can be less than about 1 foot. The distances D1, D2, and D3 can vary widely depending on the design of the motion detector 320. In addition, the distances D1, D2, and D3 can be changed by a user.

In some embodiments, if the object 301 continues to approach the motion detector 320 beyond a certain point, the red light 310a can start blinking. In another embodiment, the replica traffic light 300 can produce a sound indicating that the object 301 is within a predetermined distance from the motion detector 320.

Referring back to FIG. 2, the replica traffic light 200 can turn on and off the lights 10 according to signals from the audio detector 30. As described above, the audio detector 30 can detect the frequency, volume, and/or rhythm of a sound, and generate a signal corresponding to those of the sound. The processor 60 of the replica traffic light 200 can sequentially or simultaneously turn on and off the lights 10 as programmed upon receiving the signal from the audio detector 30.

In yet another embodiment, the replica traffic light 200 can turn on and off the lights 10 according to signals from the gas/smoke detector 40. As described above, the gas/smoke detector 40 can generate a signal if a gas and/or smoke in the air is in an amount greater than a predetermined value. The processor 60 of the replica traffic light 200 then turns on and off the lights 10 as programmed. For example, the replica traffic light 200 can make only the red light 10a blink. In certain embodiments, the replica traffic light 200 can also include a speaker which generates an alarm sound.

In another embodiment, the replica traffic light 200 can control the lights 10 according to signals for the light detector 50. As described above, the light detector 50 can generate a signal if visible light has a luminance greater than a predetermined value. The processor of the replica traffic light 200 can control the lights 10 as programmed upon receiving the signal from the light detector 50.

In certain embodiments, the processor 60 of the replica traffic light 200 can be configured to be turned on upon receiving a signal from the light detector 50. In one embodiment, the processor 60 can be turned on only if the light detector 50 detects visible light having a luminance above a predetermined value. In another embodiment, the processor 60 can be turned on only if ambient light has a luminance lower than a predetermined value. As described above, the light detector 50 can be configured to generate a signal when ambient light has a luminance lower than a predetermined value. In such an embodiment, the processor 60 can be in operation only in a dark environment.

In certain embodiments, the replica traffic light 200 can have the lights 10 turned on and off randomly for a predetermined period of time upon receiving a signal from at least one of the detectors 20, 30, 40, 50. It will be appreciated that the duration of such a random operation of the lights 10 can vary depending on the design of the replica traffic light 200.

The replica traffic light according to the embodiments described above can be used both decoratively and functionally. For example, the replica traffic light can be located in a living room or children's room for decorative purposes. In addition, the replica traffic light can serve as a motion detector, audio detector, gas/smoke detector, or light detector at the same location. In another embodiment, the replica traffic light can be used in a garage primarily as a motion detector. The replica traffic light can also serve as a light detector or gas/smoke detector in the garage.

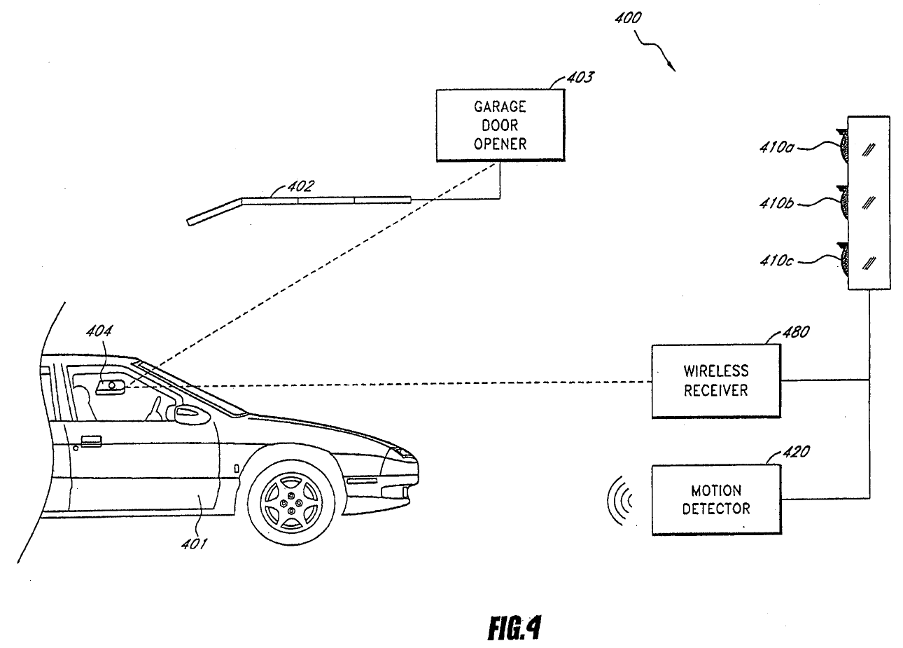

FIG. 4 illustrates one embodiment of a replica traffic light 400 serving as a parking assistant in a garage. In the illustrated embodiment, the replica traffic light 400 includes three lights 410a, 410b, 410c, a motion detector 420, a wireless receiver 480, and a processor (not shown). In other embodiments, the replica traffic light 400 can also have other detectors as described above. The illustrated garage includes a garage door 402 and a garage door opener 403. The garage door opener 403 can be operated using a remote controller 404.

The three lights include a red light 410a, a yellow light 410b and a green light 410c. The configurations of the lights 410a, 410b, 410c are as described above with respect to those shown in FIG. 1.

The motion detector 420 is configured to detect motion of a vehicle while it enters the garage. The motion detector 420 is positioned at a location suitable for detecting motion of a vehicle. In one embodiment, the motion detector 420 is positioned on a wall facing a vehicle entering the garage. It will be appreciated that the position of the motion detector 420 can vary depending on the configuration of the motion detector 420 and the garage structure.

The wireless receiver 480 is configured to detect a signal emitting from the remote controller 404 of the garage door opener 403. The garage door opener 403 is configured to open or close the garage door 402 upon receiving a signal from the remote controller 404. The signal can be an infrared signal typically used for remote controllers. Upon receiving a signal from the remote controller 404, the wireless receiver 480 generates a signal which turns on the processor of the replica traffic light 400. Then, the processor turns on the motion detector 420. In certain embodiments, the replica traffic light 400 can receive a signal from the garage door opener 403 via a wired connection and can not have a wireless receiver. A skilled artisan will appreciate that various methods for receiving a signal from the remote controller 404 are possible.

The replica traffic light 400 operates as a parking assistant as follows. When a vehicle 401 approaches the garage door 402, the driver presses a button on the remote controller 404. The remote controller 404 transmits a signal to the garage door opener 403. Then, the garage door opener 403 opens the garage door 402. When the signal is transmitted to the garage door opener 403, the wireless receiver 480 detects the signal. Then, the processor and the motion detector 420 are turned on as described above. The motion detector 420 then detects motion of the vehicle 401. When the vehicle 401 is beyond a predetermined distance from the motion detector 420, the green light 410c is turned on. As the vehicle 401 further approaches the motion detector 420, the green light 410c is turned off, and the yellow light 410b is turned on. When the vehicle 401 arrives at a stop position, the yellow light 410b is turned off, and the red light 410a is turned on. The driver can follow the change of the lights 410a-410c to safely park the vehicle 401 at a designated position.

In another embodiment, the replica traffic light 400 can include a light detector positioned within the garage. The processor of the replica traffic light 400 can be turned on upon receiving a signal from the light detector. During daytime, when the garage door 402 is opened by the garage door opener 403, the light detector is exposed to light from outside the garage. During nighttime, the light detector is exposed to a headlight from a vehicle when the vehicle enters the garage. When the light detector is exposed to light, it generates a signal, which turns on the processor of the replica traffic light. Then, the processor turns on and off the lights 410a-410c as programmed as the vehicle approaches the motion detector 420 as described above.

The foregoing description is that of embodiments of the invention and various changes, modifications, combinations and sub-combinations can be made without departing from the spirit and scope of the invention, as defined by the appended claims.

What is claimed is:

1. A multi-function replica traffic light device, comprising:
a plurality of lights of different colors aligned in a direction;
at least two selected from the group consisting of a motion detector, a timer, an audio detector, a gas detector, a smoke detector, and a visible light detector, each configured to generate a signal; and
a processor configured to turn on and off the plurality of lights in response to the signal.

2. The device of claim 1, wherein the device comprises at least three selected from the group.

3. The device of claim 1, wherein the device comprises at least four selected from the group.

4. The device of claim 1, wherein the device comprises at least five selected from the group.

5. The device of claim 1, wherein the device comprises the motion detector, the timer, the audio detector, the gas detector, the smoke detector, and the visible light detector.

6. The device of claim 1, wherein the plurality of lights comprise a red light, a yellow light, and a green light.

7. The device of claim 1, wherein the direction comprises one of a vertical direction and a horizontal direction.

8. The device of claim 1, wherein the processor is configured to sequentially turn on and off the plurality of lights.

9. The device of claim 1, wherein the processor is configured to randomly turn on and off the plurality of lights.

10. The device of claim 1, wherein the motion detector is configured to detect motion of an object and generate a signal in response to the motion.

11. The device of claim 10, wherein the motion detector comprises a sensor using at least one selected from the group consisting of a radio frequency wave, infrared, microwave, and ultrasound.

12. The device of claim 1, wherein the timer is configured to set a duration for which the processor is on.

13. The device of claim 1, wherein the audio detector is configured to detect a sound and generate a signal in response to the sound.

14. The device of claim 13, wherein the audio detector is configured to detect at least one selected from the group consisting of the frequency, volume, and rhythm of the sound.

15. The device of claim 1, wherein the gas detector is configured to detect a gas in the air and generate a signal if the gas is in an amount greater than a predetermined value.

16. The device of claim 15, wherein the gas comprises carbon monoxide.

17. The device of claim 15, wherein the gas comprises a flammable gas.

18. The device of claim 1, wherein the visible light detector is configured to generate a signal upon receiving visible light if the visible light has a luminance greater than a predetermined value.

19. The device of claim 18, wherein the processor is configured to be turned on upon receiving the signal from the visible light detector.

20. The device of claim 1, wherein the visible light detector is configured to generate a signal if ambient light has a luminance lower than a predetermined value, and wherein the processor is configured to be turned on upon receiving the signal from the visible light detector.

21. The device of claim 1, further comprising a wireless receiver configured to receive a wireless signal from a remote controller.

22. The device of claim 21, wherein the remote controller comprises a remote controller of a garage door opener, and wherein the processor is configured to be turned on upon receiving the wireless signal from the remote controller.
